(19) United States
(12) Patent Application Publication
(10) Pub. No.: US 2018/0332840 A1
(43) Pub. Date: Nov. 22, 2018

(54) CONTROL DEVICE AND PROCEDURES FOR HEIGHT ADJUSTMENT OF VEHICLE BOOMS

(71) Applicant: BAUMER ELECTRIC AG, FRAUENFELD (CH)

(72) Inventors: MICHAEL WEIGEL, MUELLHEIM (CH); RAINER MAUCH, HILZINGEN (DE)

(73) Assignee: BAUMER ELECTRIC AG, FRAUENFELD (CH)

(21) Appl. No.: 15/983,102

(22) Filed: May 18, 2018

(30) Foreign Application Priority Data
May 19, 2017 (DE) 10 2017 004 808.8

(51) Int. Cl. A01M 7/00; A01B 79/00; A01B 63/00; A01D 41/127

(52) U.S. Cl. CPC A01M 7/0057; A01B 79/005; A01D 41/141; A01D 41/127; A01M 7/0089; A01B 63/008

(57) ABSTRACT

A control device for controlling a height of a boom of a vehicle. The control device includes a transmission/receiver set, a processor, a control, and a communication interface. The transmission/receiver set transmits an initial measuring signal and receives an initial reflection signal in response thereto, and transmits a second measuring signal and receives a second reflection signal in response thereto. The processor determines a majority of initial reflection components of the initial reflection signal, a majority of second reflection components of the second reflection signal, and compares the initial reflection components with the second reflection components to determine matching reflection components. The matching reflection components indicate a layer of reflection objects. The communication interface links the processor with the control and to determine a control signal for controlling the boom based on the matching reflection components.

### CROSS REFERENCE TO PRIOR APPLICATIONS

Priority is claimed to German Patent Application No. DE 10 2017 004 808.8, filed May 19, 2017. The entire disclosure of said application is incorporated by reference herein.

### FIELD

The present invention relates to a control device and process for adjusting the height of a vehicle boom.

### BACKGROUND

State-of-the-art distance measurement devices such as ultrasonic sensors, radar sensors or optical sensors are used to determine and display the distance between one object and one nearest thereto. These sensors display the distance measured mostly in the form of a distance-proportional and analog voltage or current value which indicates the presence of an object in a defined detection zone. This suffices in technical applications, such as those found in machine engineering or in the process industry, because the only one item of information required is the distance to an identified object and becasue the object to be measured has a defined surface.

In technical applications, however, such as in the agricultural sector, it often does not suffice simply to determine the position or distance to just one object. Applications of this type often require the identification of a number of objects in a defined detection zone as well as the respective distances to each of these objects and/or the detection of the position of each of these objects in relation to another object; for example, a vehicle or an attachment to the vehicle.

Examples where requirements of this kind must be met are found particularly in the agricultural sector. For example, when controlling and adjusting the height of a boom, in particular a field boom, a spray bar or a mower attached to a vehicle in relation to the ground surface on which the vehicle is standing by means of a control device on this vehicle. The vehicle might, for example, be an agricultural machine. It is therefore not sufficient in these types of applications to identify just one single object and to determine the distance of this object to the vehicle, wherein the object might be a single plant or the ground surface on which the vehicle in question is moving. On the contrary, the distance to a multitude of plants and/or single objects, for example, a crop canopy as well as the distance to the ground surface, must be established and identified in order to be able to adjust and set the height of the boom accordingly. Measurements must be made through the plants for this purpose. This is difficult because such measurements create many reflections which are then reflected back by a multitude of individual objects, for example, by a multitude of individual plants and the ground surface. These multiple reflections must then be evaluated accordingly in order to identify a possible number of objects and to be able to determine the positions and/or distances to this number of objects. A further problem when making such measurements identifying as many objects as possible is to distinguish with sufficient certainty and/or statistical reliability whether the reflection signals received have indeed been generated by a real or actual object, such as a plant or the ground surface, or whether they are merely incidental and temporary disturbances in the form of interference signals or noise which have become mixed in with the multiple reflection signals received. The distance to a crop canopy and the distance to the ground surface can, for example, only be determined after evaluating and considering the above-described aspects of received reflection signals of an appropriate quality which will allow the height of the the boom on such an agricultural machine to be set with sufficient and specified accuracy using a control device. This is not possible using state-of-the-art vehicle control devices which feature only the distance-measuring sensors previously described because these commercially available sensors can only measure one distance to one object and are therefore only able to identify a single object.

### SUMMARY

An aspect of the present invention is to further develop a control device and a process to control the height adjustment for a vehicle to reduce the above-described disadvantages and to provide an efficient method of identifying a number of objects with a high degree of qualitative and reliable accuracy.

In an embodiment, the present invention provides a control device for controlling a height of a boom of a vehicle. The control device includes a transmission/receiver set, a processor, a control, and a communication interface. The transmission/receiver set is configured to transmit an initial measuring signal and, in response thereto, to receive an initial reflection signal, and to transmit a second measuring signal and, in response thereto, to receive a second reflection signal. The processor is configured to determine a majority of initial reflection components of the initial reflection signal in the initial reflection signal, to determine a majority of second reflection components of the second reflection signal in the second reflection, and to compare the initial reflection components with the second reflection components in order to determine matching reflection components occurring in the initial reflection signal and the second reflection signal, wherein, the matching reflection components indicate a layer of reflection objects. The communication interface is configured to link the processor with the control and to determine a control signal for controlling the boom based on the matching reflection components.

### BRIEF DESCRIPTION OF THE DRAWINGS

The present invention is described in greater detail below on the basis of embodiments and of the drawings in which:

FIG. 1 shows a schematic representation of an embodiment of the control device in a vehicle of the present invention; and

FIG. 2 shows a diagram of a process to control the boom height on a vehicle.

### DETAILED DESCRIPTION

In an embodiment, the present invention provides a control device to adjust the height of a vehicle boom. The control boom is equipped with a transmitter/receiver set designed to transmit an initial measuring signal and then, in response to the transmission of the first measuring signal, to receive an initial reflection signal. Provision is furthermore made for a processor designed to determine most of the initial reflection components in the initial reflection signal of the first measuring signal. The transmission/receiver system is designed to transmit a second measuring signal and then, in response to the transmission of the second measuring signal, to receive a second reflection signal. The processor is designed to determine most of the second reflection components of the second reflection signal in the second reflection signal. The processor is further designed to compare the initial reflection components with the second reflection components in order to determine a number of matching reflection components which occur in the first reflection signal and in the second reflection signal, whereby the matching reflection components indicate a layer of reflection objects. A control device is furthermore provided which can be linked to the processor via a communication interface. The control device is designed to determine a control signal to control the boom on the basis of the matching reflection components.

The advantage of the control device of the present invention is that it can efficiently identify, within a defined detection zone of the vehicle, a multitude of (different) single objects and/or reflection objects with qualitatively high and reliable accuracy, thus allowing a better and more efficient determination of distances and positions of this large number of individual objects in relation to the vehicle. This presents a prerequisite for controlling and setting the height of the vehicle boom.

In addition to the reliable and certain identification of a multitude of objects which in the context of the present invention are called “reflection objects”, a further advantage is that any disturbances caused by noise or interference signals can be efficiently suppressed and filtered out. This provides increased accuracy with which a multitude of reflection objects can be distinguished from incidental disturbances. This in turn leads to a higher level of quality of the individually determined distances of the so-called recognizably valid and/or identified reflection objects relating to the vehicle. The control device of the present invention can consequently efficiently and reliably distinguish between identified reflection objects and disturbances which occur in the form of interference signals. Only those reflection objects which have been recognized as valid can therefore contribute in the determination of individual distances.

The determined distances to the identified reflection objects can be used to control vehicle boom height. This is not, however, the limit of its technical deployment. It is equally possible to correspondingly set and control the height of a vehicle mower to the crop canopy or ground surface using the control device of the present invention and the process.

The vehicle can be provided as an agricultural machine.

In the context of the present invention, plants, leaves, and the ground surface are, for example, considered to be reflection objects.

The fundamental concept behind the control device and the corresponding process for controlling boom height on a vehicle of the present invention is its efficiency in reliably identifying and/or detecting a variety of different reflection objects within a defined detection zone together with their respective positions while at the same time suppressing and filtering out any incidental disturbances which would negatively impact the accuracy of height control. The detection zone is the area in which the respective transmitted measuring signals from the transmitter/receiver set of the control device are captured. This occurs by comparing the initial reflection components with the second reflection components in order to determine a number of matching reflection components which occur in the first reflection signal and the second reflection signal, whereby the matching reflection components indicate a layer of reflection objects. The respective distances to these identified reflection objects and each of the signal strengths belonging to these reflection objects can be determined using the information on the layer or so-called position information of individual reflection objects from a multitude of reflection objects. From the distance information determined in each case and/or from position information on the recognized and/or identified individual reflection objects, the distances or the clearance to a crop canopy or ground surface can in particular be determined in order to correspondingly control and adjust the boom height of a mower machine, or other agricultural equipment, or of any other vehicle operational equipment which can be controlled by the control device of the present invention, to the crop canopy and/or ground surface.

In an embodiment of the present invention, the processor can, for example, be designed to transform the initial measuring signal into a transformed measuring signal via a frequency transformation, and in particular by means of a Fourier transformation, whereby the initial reflection components are the initial spectral components of the first transformed measuring signal at differing frequencies, and whereby the processor is designed to transform the second measuring signal into a second transformed measuring signal via a frequency transformation, whereby the second reflection components are second spectral components of the second transformed measuring signal at differing frequencies. The resulting advantage leads to the generation of a distance-proportional signal path.

In an embodiment of the present invention, the processor can, for example, be designed to compare the respective measuring signal with a threshold value and to display the respective spectral components as respective reflection components which do not lie below the threshold value. The advantage achieved thereby is that so-called “valid reflection objects” are recognized as such and false reflection objects, which in the form of incidental disturbances or noise which can distort the distance measurements to the reflection objects, are filtered out.

In an embodiment of the present invention, the processor can, for example, be designed to not display the respective spectral components of the respective measuring signal as respective reflection components which lie below the threshold value. The advantage achieved thereby that a kind of pre-filtering takes place in which disturbances or interference signals are filtered from the reflection signals received.

In an embodiment of the present invention, the threshold value can, for example, represent a value for a certain signal strength of the respective measuring signal. The advantage achieved thereby is that disturbances or interference signals from the reflection signals received, which might possibly only occur once, are efficiently filtered out.

In an embodiment of the present invention, the processor can, for example, be designed to determine, when comparing the initial reflection components with the second reflection components, a number of non-matching reflection components which occur either in the initial reflection signal or in the second reflection signal, whereby the non-matching reflection components indicate that the initial reflection signals received or the second reflection signals received were not reflected by a reflection object and therefore represent a disturbance. The advantage achieved thereby is that disturbances or interference signals, which possibly occur only once, are filtered out of the reflection signals received and are therefore not recognized and/or identified as reflection objects for which position information in the form of a distance value must be determined.

In an embodiment of the present invention, the processor can, for example, designed to determine the respective layers of reflection objects as individual position information for these reflection objects which, for reason of their matching reflection components in the initial reflection signal and the second reflection signal, have been identified as such in relation to the vehicle boom. The advantage thereof is that a distance in the form of position information from the vehicle boom to the respective reflection object can be ascertained.

In an embodiment of the present invention, the processor can, for example, be designed to store, in a list of reflection objects, the individual position information on reflection objects which, for reason of matching reflection components in the initial reflection signal and the second reflection signal, have been identified as such and/or the signal strengths of the respective reflection components which are assignable as such identified reflection objects. The list of reflection objects is displayable via the communication interface on the control device in order to determine the control signal for controlling the boom. The advantage thereof is that, from this list of reflection objects, different distances can be used for further processing depending on demand and requirements. The distance of the boom to the crop canopy or ground surface can be determined in each case, for example, from the multitude of values stored in the object list. The values can themselves then be stored in the object list and can be retrieved at a later date to control the height of a boom or other operating equipment on the vehicle and to adjust promptly and flexibly the vehicle to the geographical circumstances of the detection zone in which the vehicle is in operation. A further advantage is that the values in the reflection object list are available at any time for further processing by the control device.

The control device can be linked via the communication interface to the control device of the present invention. The communication interface can thereby be designed, for example, as a serial data interface.

In an embodiment of the present invention, the transmitter/receiver set can, for example, be based on radar, in particular FMCW radar, or an ultrasonic-based transmitter/receiver device. The advantage thereof is that the type of evaluation and data issue is not limited to just one type of sensor. The transmitter/receiver set can comprise a radar sensor or an ultrasonic sensor or an optical sensor, depending on the area of application.

In an embodiment, the present invention provides a process for controlling the height of a vehicle boom. The process comprises the steps of:
transmission of an initial measuring signal via a transmission/receiver system and, in response to the transmission of the initial measuring signal, the reception of an initial reflection signal;
determination of a multitude of initial reflection components from the initial reflection signal via a processor;
transmission of a second measuring signal and, in response to the transmission of a second reflection signal, the reception of a second reflection signal via the transmitter/receiver set;
determination in the second reflection signal of a multitude of second reflection components of the second reflection signals via the processor;
comparison of the initial reflection components with the second reflection components via the processor in order to determine a number of matching reflection components occurring in the initial reflection signal and in the second reflection signal, whereby the matching reflection components indicate a layer of reflection objects; and
determination of a control signal to control the boom on the basis of matching reflection components via a control device. The process of the present invention also generates the advantages described for the control device of the present invention.

The process can be carried out using the control device of the present invention.

In an embodiment, the present invention provides a vehicle, in particular an agricultural vehicle, which includes the control device of the present invention.

Further examples of the design of the present invention are shown in the drawings which are described in greater detail below.

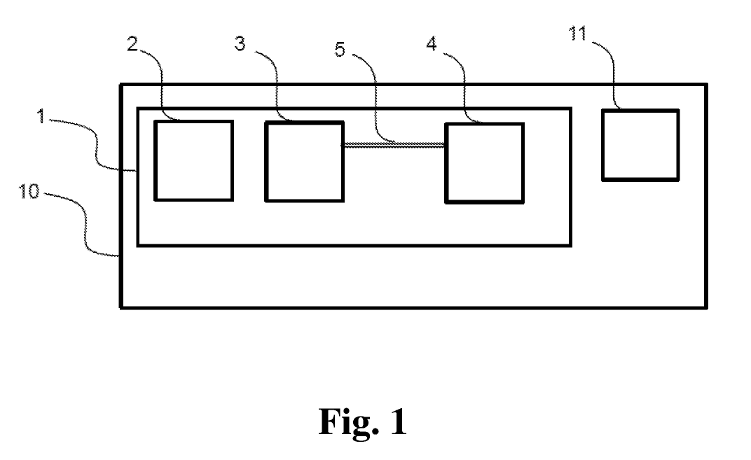

FIG. 1 shows a schematic representation of the control device 1 of the present to control the height or distance of a boom 11 in a vehicle 10. In the context of the present invention, the control device 1 can also be understood to be a measuring device with which to measure the height or clearance of the boom 11 in the vehicle 10. The measuring of the height and/or clearance of the boom 11 in the vehicle 10 is thereby not limited to metrological aspects, but can also comprise control and/or regulation of the height of the boom 11 in the vehicle 10.

The vehicle 10 can be an agricultural vehicle, for example, a field machine. The boom 11 can be designed as a field boom. Boom 11 in the context of the present invention to be understood as an example. Boom 11 might also be a mower or another item of height-adjustable operating equipment on vehicle 10 whose height is controlled by the control device 1. Boom 11 can also be an attached implement or an attachment device or a means of operation, for example, a spraying device for distributing a fluid or a gas within a defined detection zone of the control device 1 of the present invention.

The control device 1 of the present invention for controlling the height of the boom 11 of the vehicle 10 comprises a transmission/receiver set 2 which is designed to transmit an initial measuring signal and, in response to the transmission of the initial measuring signal, to receive an initial reflection signal. A processor 3 is to be provided, the processor 3 being designed to determine, in the initial reflection signal, multiple initial reflection components of the first reflection signal. The transmission/receiver set 2 is designed to transmit a second measuring signal and, in response to the transmission of the second measuring signal, to receive a second reflection signal. Processor 3 is designed to determine in the second reflection signal multiple second reflection components of the second reflection signal. Processor 3 is also designed to compare the initial reflection components with the second reflection components in order to determine a number of matching reflection components occurring in the initial reflection signal and the second reflection signal, whereby the matching reflection components indicate a layer of reflection objects. The control device 1 of the present invention further comprises a control 4 which can be linked to the processor 3 via a communication interface 5 and whereby the control 4 is designed to determine a control signal for controlling the boom 11 on the basis of matching reflection components.

The communication interface 5 can be designed as a serial, bi-directional data interface, in order to allow data communication between the control device 1 and control 4.

The transmission/receiver set 2 can be radar-based, in particular FMCW radar, or an ultrasonic-based transmission/receiver set. An FMCW radar emits a so-called sweep of electro-magnetic signals which are reflected to the respective reflection objects and which are received again, time-delayed, by the transmission/receiver set 2. A difference between a transmission and receiver frequency is then measured from which the duration of the electro-magnetic signals is determined. The transmission/receiver set 2 can, however, also comprise an optical sensor with which to send out optical signals.

It must be mentioned in connection therewith that the present invention is not restricted for use only with corresponding signals when employing an FMCW radar. The present invention can also be used to its full extent for signals in the time range, i.e., if perhaps an ultrasonic-based transmission/receiver set is used. The relevant measuring signals and the emerging reflection components and/or spectral components can therefore also be read for signals in the time range and/or comprise such signals.

Processor 3 can be a micro-controller comprising a clearance filter based on a multi-target tracking filter.

Processor 3 can be designed to transform the initial measuring signal via frequency transformation, especially via a Fourier transformation, into an initial transformed measuring signal, whereby the initial reflection components are the initial spectral components of the initial transformed measuring signal at varying frequencies, and whereby processor 3 is designed to transform the second measuring signal via frequency transformation into a second transformed measuring signal, whereby the second reflection components are second spectral components at varying frequencies. The Fourier transformation can generate a distance-proportional signal path.

Processor 3 can furthermore be designed to compare the respective measuring signal with a threshold value and to display the respective spectral components as respective reflection components which do not lie below the threshold values. This provides that the (valid) reflection objects are identified as such and the supposedly (false and/or invalid) reflection objects which, however, do not represent any reflection objects in the real sense of the meaning but are only disturbances or noises, are filtered out. This can, for example, be done via a so-called peak location algorithm which subtracts the respective spectral components which might be present as respective frequency peaks of the transformed measuring signal. In other words, peaks featuring a certain signal strength are filtered out in order to distinguish a signal strength of a (valid) reflection object from a signal strength of an incidental noise or interference signal. For these individual frequency peaks, their clearance or distance or layer in the form of position information can be determined in relation to the vehicle 10 or the boom 11 of the vehicle 10 and their signal strengths.

Processor 3 can be designed not to display the respective spectral components of the respective measuring signal as respective reflection components below the threshold value. The threshold value can, for example, be a value for a pre-determined signal strength of the respective measuring signal. It is thus easy to distinguish disturbances in the form of interference signals from reflection objects and to filter them out. A so-called false reflection signal received as an interference signal might have been caused, for example, by an insect which just happened to be on a certain spot when the signal was transmitted.

When comparing the initial reflection components with the second reflection components, processor 3 can be designed to determine a number of non-matching reflection components which occur either in the initial reflection signal or in the second reflection signal, whereby the non-matching reflection components indicate that the initial reflection signal received or the second reflection signal received was not reflected by a reflection object and thus represents disturbance. Disturbances or interference signals which possibly occur only once can thereby be efficiently filtered out to provide that such disturbances are not identified as reflection objects and then incorrectly included in the determination of equally false position information or a layer of reflection objects.

Processor 3 can be designed to determine individual position information of these reflection objects which were identified as such on the basis of matching reflection components in the first reflection signal and the second reflection signal in relation to the boom 11 on the vehicle 10. Position information of a reflection object can therefore represent a value for a layer of these reflection objects. A layer can, however, be regarded as a clearance or a distance of a reflection object in relation to the boom 11, or more generally, an item of operating equipment for a vehicle 10 which can be height adjusted.

Processor 3 can furthermore be designed to store, in a list of reflection objects, the individual position information of reflection objects which, for reason of matching reflection components in the first reflection signal and the second reflection signal, have been identified as such, and/or the signal strengths of the respective reflection components which are assignable thereto as such identified reflection objects, whereby the list of reflection objects is displayable via the communication interface 5 on control 4 in order to determine the control signal for controlling the boom 11 therefrom. The list of reflection objects can be therefore be used at any time for further processing by control 4.

Such a list of reflection objects therefore contains a collection of or entries of information for different layers or clearances and/or positions of different plausibly identified reflection objects and a value for a signal strength of the respective reflection signal which is re-transmitted at a relevant and determined layer or position by a reflection object in form of its relevant reflection signal. A reflection object can be declared as plausible if it has been recognized and/or identified as such with a certain level of assurance or statistical probability and it does not represent an interference signal. In an ideal case, the list of reflection objects contains a list of (differing) plausible reflection objects whose respective position and signal strength have already been filtered out by a such a plausible reflection object, not, however, disturbances or reflection objects camouflaged as interference signals because these, as described above, have already been filtered out.

It must be mentioned in this connection that a reflection object will be/is recognized and/or identified as such if its characteristic reflection signal coupled with a corresponding signal strength (the term is called also a signal echo) appears frequently. That is the case when following a number of transmitted initial and second measuring signals, a reflection signal with exactly the already known signal strength, occurs repeatedly and/or is received by the transmission/receiver set 2 on the control device 1 always at the respective position, or, in other words, at which respective determined positions such reflection signals (and their respective signal strengths) accumulate and/or are repeated after a number of measuring cycles. It can be derived therefrom whether a received reflection signal has been reflected by a (valid) reflection object whose distance from vehicle 10 and/or boom 11 on vehicle 10 is relevant for the determination and control of the height of boom 11, for example, a leaf, or whether the received reflection signal is merely an incidental and one-off disturbance which can be ignored. Reflection signals which occur sporadically suggest rather an incidental disturbance which is then not identified and stored as a reflection object by processor 2, but is ignored.

With the help of special-purpose filter algorithms, for example, a clearance and/or several clearances or distances to a crop canopy or ground surface can be determined from this list of reflection objects in order to be able to correct the height of the boom accordingly.

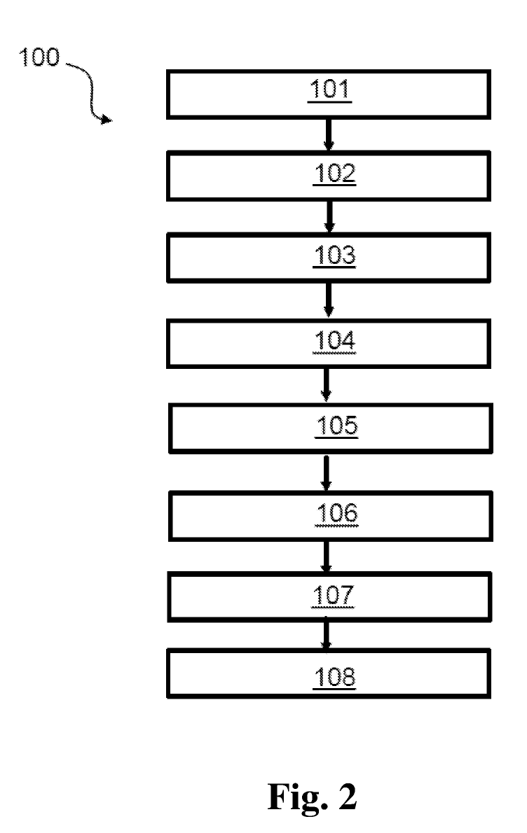

FIG. 2 shows a diagram of a process 100 for controlling the height of a boom 11 on a vehicle 10. Process 100 comprises an initial step 101, i.e., the transmission of an initial measuring signal using the transmission/receiver set 2 and, in response to the transmission of the initial measuring signal, a second step 102, i.e., the receipt of an initial reflection signal. Process 100 comprises a third step 103, i.e., the determination of several initial reflection components of the initial reflection signal from the initial reflection signal by processor 3. Process 100 comprises a fourth step 104, i.e., the transmission of a second measuring signal in response to the transmission of the second measuring signal. The process 100 comprises a fifth step 105, i.e., the receipt of a second reflection signal by the transmission/receiver set 2. Process 100 comprises a sixth step 106, i.e., the determination in the second reflection signal of most of the second reflection components of the second reflection signal by processor 3. Process 100 comprises a seventh step 107, i.e., the comparison of the initial reflection components with the second reflection components by processor 3 in order to determine a number of matching reflection components which occur in the initial reflection signal and in the second reflection signal, whereby the matching reflection components indicate a layer of reflection objects. Process comprises an eighth step 108, i.e., the determination of a control signal to control the boom 11 on the basis of matching reflection components by the control 4.

The present invention is not limited to embodiments described herein; reference should be had to the appended claims.

What is claimed is:

1-10. (canceled)

11. A control device for controlling a height of a boom of a vehicle, the control device comprising:
a transmission/receiver set configured to,
transmit an initial measuring signal and, in response thereto, to receive an initial reflection signal, and
transmit a second measuring signal and, in response thereto, to receive a second reflection signal;
a processor configured to,
determine a majority of initial reflection components of the initial reflection signal in the initial reflection signal,
to determine a majority of second reflection components of the second reflection signal in the second reflection, and
to compare the initial reflection components with the second reflection components in order to determine matching reflection components occurring in the initial reflection signal and the second reflection signal, wherein the matching reflection components indicate a layer of reflection objects;
a control; and
a communication interface configured to link the processor with the control and to determine a control signal for controlling the boom based on the matching reflection components.

12. The control device as recited in claim 11, wherein the processor is further configured to,
transform the initial measuring signal, via a first frequency transformation, into an initial transformed measuring signal, wherein the initial reflection components are initial spectral components of the initial transformed measuring signal at varying frequencies, and
transform the second measuring signal, via a second frequency transformation, into a second transformed measuring signal, wherein the second reflection components are second spectral components of the second transformed measuring signal at varying frequencies.

13. The control device as recited in claim 12, wherein at least one of the first frequency transformation and the second frequency transformation is a Fourier transformation.

14. The control device as recited in claim 12, wherein the processor is further configured to:
compare the initial transformed measuring signal and the second transformed measuring signal with a threshold value, and
display the initial spectral components of the initial transformed measuring signal and the second spectral components of the second transformed measuring signal which do not lie below the threshold value.

15. The control device as recited in claim 13, wherein the processor is further configured not to display the initial spectral components of the initial transformed measuring signal and the second spectral components of the second transformed measuring signal as reflection components which lie below the threshold value.

16. The control device as recited in claim 14, wherein the threshold value represents a value for a certain signal strength of the initial transformed measuring signal and the second transformed measuring signal.

17. The control device as recited in claim 11, wherein,
the processor is further configured to determine, either in the initial reflection signal or in the second reflection signal, non-matching reflection components when comparing the initial reflection components with the second reflection components, and
the non-matching reflection components indicate that the initial reflection signal received or the second reflection signal received was not reflected by a reflection object and therefore represents a disturbance.

18. The control device as recited in claim 11, wherein the processor is further configured to determine respective layers of reflection objects as individual position information in relation to the boom of the vehicle based on the matching reflection components in the initial reflection signal and in the second reflection signal.

19. The control device as recited in claim 18, wherein,
the processor is further configured to store in a list of reflection objects the individual position information on the reflection objects based on at least one of,
the matching reflection components in the initial reflection signal and the second reflection signal being identified as reflection objects, and
signal strengths of the respective initial reflection components and second reflection components being assignable as recognized reflection objects, and
the list of reflection objects is displayed via the communication interface on the control so as to determine the control signal for controlling the boom therefrom.

20. The control device as recited in claim 11, wherein the transmission/receiver set is based on a radar or an ultrasonic transmission/receiver set.

21. The control device as recited in claim 20, wherein the radar is a FMCW radar.

22. A process for controlling a boom height on a vehicle, the process comprising:
transmitting, via a transmission/receiver set, an initial measuring signal;
receiving, via the transmission/receiver set, an initial reflection signal in response to the transmitting of the initial measuring signal;
determining, via a processor, a majority of initial reflection components of the initial reflection signal from the initial reflection signal;
transmitting, via the transmission/receiver set, a second measuring signal;
receiving, via the transmission/receiver set, a second reflection signal in response to the transmitting of the second measuring signal;
determining, via the processor, a majority of second reflection components of the second reflection signal from the second reflection signal;
comparing, via the processor, the initial reflection components with the second reflection components in order to determine matching reflection components which occur in the initial reflection signal and in the second reflection signal, wherein the matching reflection components indicate a layer; and
determining, via a control device, a control signal for controlling the boom based on the matching reflection components.
